(19) United States
(12) Patent Application Publication
(10) Pub. No.: US 2020/0142235 A1
(43) Pub. Date: May 7, 2020

(54) Package Substrate Mechanism, Display Panel, and Display Device

(71) Applicants: CHONGQING ADVANCE DISPLAY TECHNOLOGY RESEARCH, Chongqing (CN); Chongqing HKC Optoelectronics Technology Co., Ltd., Chongqing (CN)

(72) Inventor: Min Li, Chongqing (CN)

(21) Appl. No.: 16/451,055

(22) Filed: Jun. 25, 2019

Related U.S. Application Data
(63) Continuation of application No. PCT/CN2018/115165, filed on Nov. 13, 2018.

(30) Foreign Application Priority Data
Nov. 5, 2018 (CN) 201821809334.3

(51) Int. Cl. G02F 1/1339; G02F 1/1362; G02F 1/1335

(52) U.S. Cl. CPC G02F 1/13392; G02F 1/136209; G02F 2001/133354; G02F 2001/136222; G02F 2001/133519; G02F 1/133514

(57) ABSTRACT

Disclosed are a packaging substrate mechanism, a display panel and a display device. The packaging substrate mechanism includes a substrate, the substrate is defined with a first coating region, a second coating region and a spacing region. An inner retaining wall and an outer retaining wall are distributed in the spacing region.

### CROSS REFERENCE TO RELATED APPLICATIONS

This application is a Continuation Application of international application of PCT/CN2018/115165 filed on Nov. 13, 2018, which claims the benefit of Chinese patent application No. 201821809334.3 entitled “Package Substrate Mechanism, Display Panel, and Display Device” dated Nov. 5, 2018, which is hereby incorporated by reference in its entirety.

### TECHNICAL FIELD

The present application relates to the technical field of display, in particular to a package substrate mechanism, a display panel, and a display device.

### BACKGROUND

Display devices such as computer displays and televisions are being used more and more widely. In the manufacturing process of display panels of existing display devices, when the alignment liquid is applied to the package substrate mechanism to form an alignment layer, the alignment liquid tends to spread out and overlap with the seal, influencing the quality of the cell.

### SUMMARY

The main purpose of the present application is to provide a package substrate mechanism, a display panel and a display device, aimed at solving the problem that in the manufacturing process of the existing display panel, alignment liquid is easily spread out and overlapped with seal, thus influencing the quality of the cell.

In order to achieve the above-mentioned objective, the present application provides a package substrate mechanism including:

a substrate having a first coating region and a second coating region located outside the first coating region, and the first coating region and the second coating region are defined in intervals to form a spacing region between the first coating region and the second coating region.

The inner retaining wall and the outer retaining wall are convexly defined on the substrate, and the inner retaining wall and the outer retaining wall are distributed in the spacing region and are defined around the first coating region.

Optionally, the inner retaining wall is defined in a ragged manner along a circumferential direction of the first coating region.

Optionally, an upper end of the inner retaining wall is defined with a gap, so that the inner retaining wall is defined in a ragged manner.

Optionally, a receiving region is formed between the inner retaining wall and the outer retaining wall, and a part of the receiving region is concavely defined compared with other parts to form an anti-overflow groove.

Optionally, the inner retaining wall is defined in a ragged manner along a circumferential direction of the first coating region, and the anti-overflow groove is defined correspondingly to the low-lying portion of the inner retaining wall.

Optionally, in the receiving region, the substrate is convexly defined with a plurality of spacer blocks connecting the inner retaining wall and the outer retaining wall, the spacer blocks are defined at intervals along a circumferential direction of the first coating region, and the anti-overflow groove is formed between two adjacent spacer blocks.

Optionally, the spacer block is integrally formed with the inner retaining wall and the outer retaining wall.

Optionally, the anti-overflow grooves are formed in a plurality along a circumferential direction of the first coating region and in the receiving region.

Optionally, the inner retaining wall and the outer retaining wall are both made of an insulating material.

Optionally, the distance between the first coating region and the second coating region is a, the distance between the inner retaining wall and the outer retaining wall is b, and a−b is ≤9mm.

Optionally, a film layer is defined in the first coating region, the height of the lateral surface of the film layer is h, the height of the lowest part of the inner retaining wall is d, and h−d is ≤4 micrometers.

Optionally, the film layer includes a plurality of black matrices defined at intervals, and a red photo-resist layer, a green photo-resist layer, and a blue photo-resist layer defined between the plurality of black matrices.

Optionally, the height of the lateral surface of the film layer is the height of the black matrix.

Optionally, the inner retaining wall is defined in a ragged manner along a circumferential direction of the first coating region, and the low-lying portion of the inner retaining wall is the lowest.

Optionally, the package substrate mechanism is a color film substrate or an array substrate.

Optionally, the package substrate mechanism is a color film substrate, the substrate is defined with a black matrix, and the black matrix is convexly defined in the spacing region around the first coating region to form the inner retaining wall or the outer retaining wall.

Optionally, the packaging substrate mechanism is a color film substrate, the substrate is defined with a photo-resist layer, and the photo-resist layer is convexly defined in the spacing region around the first coating region to form the inner retaining wall or the outer retaining wall.

Optionally, the package substrate mechanism is a color film substrate, and the substrate is defined with a spacer, and the spacer is convexly defined in the spacing region around the first coating region to form the inner retaining wall or the outer retaining wall.

the present application also provides a display panel, which comprises a package substrate mechanism, wherein the package substrate mechanism comprises:

a substrate having a first coating region and a second coating region located outside the first coating region, and the first coating region and the second coating region are defined in intervals to form a spacing region between the first coating region and the second coating region.

The inner retaining wall and the outer retaining wall are convexly defined on the substrate and defined internal and external, and the inner retaining wall and the outer retaining wall are distributed in the spacing region and are defined around the first coating region.

the present application also provides a display device, which comprises a display panel, wherein the display panel comprises a packaging substrate mechanism, and the packaging substrate mechanism includes:

a substrate having a first coating region and a second coating region located outside the first coating region, and the first coating region and the second coating region are defined in intervals to form a spacing region between the first coating region and the second coating region.

The inner retaining wall and the outer retaining wall are convexly defined on the substrate and are defined internal and external, and the inner retaining wall and the outer retaining wall are distributed in the spacing region and are defined around the first coating region.

According to the technical solution provided by the present application, the alignment liquid is coated on the first coating region and the seal is coated on the second coating region. The inner retaining wall and the outer retaining wall form a double barrier to spreading out of the alignment liquid. And the region between the inner retaining wall and the outer retaining wall can accommodate part of the alignment liquid, slowing down the tendency of spreading out of the alignment liquid to the second coating region. The risk of spreading out of the alignment liquid and overlapping with the seal and influencing the quality of the cell have been reduced.

### BRIEF DESCRIPTION OF THE DRAWINGS

In order to explain the exemplary embodiments of the present application or the technical solutions in the prior art more clearly, the drawings referred in the exemplary embodiments or the description of the prior art will be briefly described in the following. Obviously, the drawings in the following description are only some exemplary embodiments of the present application. For those skilled in the art, other drawings can be conceived according to the structure shown in these drawings without paying creative effort.

FIG. 1 is a schematic structural diagram of an exemplary embodiment of a package substrate mechanism defined by the present application, wherein the height at the grid line>the height at the diagonal line>the height at the horizontal line;

FIG. 2 is a schematic cross-sectional view at A in FIG. 1;

FIG. 3 is a schematic cross-sectional view at B in FIG. 1.

### BRIEF DESCRIPTION OF THE REFERENCE NUMERALS

Brief description of the reference numerals:

| Reference | | | |
|---|---|---|---|
| numeral | Name | Grade | Name |
| 100 | package substrate | 4 | Anti-overflow |
| | mechanism | | groove |
| 1 | Base plate | 5 | Spacing block |
| 11 | The first coating | 6 | Film layer |
| | region | | |
| 12 | The second coating | 61 | Black matrix |
| | region | | |
| 2 | Inner retaining wall | 62 | Red photo-resist |
| | | | layer |
| 21 | Gap | 63 | Green photo-resist |
| | | | layer |
| 3 | Outer retaining wall | 64 | Blue photo-resist |
| | | | layer |

The realization, functional features and advantages of the purpose of this application will be further described with reference to the accompanying drawings in conjunction with the exemplary embodiments.

### DETAILED DESCRIPTION OF THE EMBODIMENTS

The technical solutions in the exemplary embodiment of the present application will be described clearly and completely in the following with reference to the drawings in the exemplary embodiment of the present application. Obviously, the described exemplary embodiment is only a part of the embodiment of the present application, but not all of the exemplary embodiments. Based on the exemplary embodiments in this application, all other exemplary embodiments obtained by a person of ordinary skill in the art without creative labor are within the scope of protection of this application.

It should be noted that if directional indications (such as up, down, left, right, front, back, etc.) are involved in the exemplary embodiments of the present application, the directional indications are only used to explain the relative positional relationship and movement between the components in a certain posture (as shown in the drawings), and if the specific posture changes, the directional indications will change accordingly.

In addition, if there are descriptions of “first” and “second” in the exemplary embodiments of the present application, the descriptions of “first” and “second” are for descriptive purposes only and cannot be understood as indicating or implying their relative importance or implicitly indicating the number of indicated technical features. Thus, features defining “first” and “second” may explicitly or implicitly include at least one such feature. In addition, the technical solutions between the various exemplary embodiments may be combined with each other, but must be based on what one of ordinary skill in the art can achieve. When the combination of technical solutions is contradictory or impossible to achieve, it should be considered that the combination of such technical solutions does not exist and is not within the scope of protection required by this application.

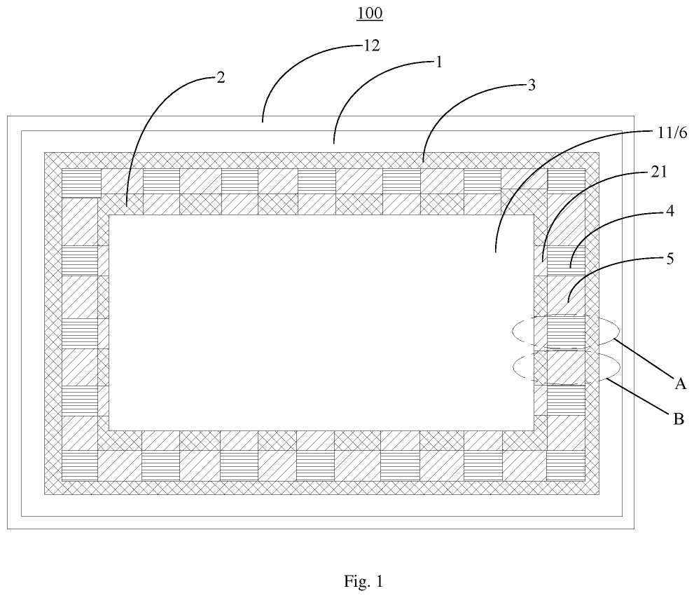

The present application provides a display device, which can be a computer display or a television, etc. hereinafter, the display device will be described by taking the display device as a computer display as an example. The display device includes a display panel including a package substrate mechanism, and FIGS. 1 to 3 are an exemplary embodiment of the package substrate mechanism defined by the present application.

In general, the display panel comprises a color film substrate and an array substrate, the array substrate and the color film substrate are oppositely defined, the color film substrate and the array substrate are connected through seal, and the packaging substrate mechanism can be the color film substrate or the array substrate. When the alignment liquid is applied to the package substrate mechanism to form an alignment layer, the alignment liquid tends to spread out and overlap with the seal, which affects the quality of the cell.

Referring to FIGS. 1 to 3, in this exemplary embodiment, the package substrate mechanism 100 includes a substrate 1, an inner retaining wall 2 and an outer retaining wall 3, the substrate 1 has a first coating region 11 and a second coating region 12 located outside the first coating region 11, and the first coating region 11 and the second coating region 12 are spaced apart to form a spacing region therebetween. The inner retaining wall 2 and the outer retaining wall 3 are convexly disposed inside and outside the substrate 1, and the inner retaining wall 2 and the outer retaining wall 3 are distributed in the spacing region and are defined around the first coating region.

According to the technical solution defined by the present application, the alignment liquid is coated on the first coating region 11 and the seal is coated on the second coating region 12, the inner retaining wall 2 and the outer retaining wall 3 form a double barrier to spreading out of the alignment liquid, and the region between the inner retaining wall 2 and the outer retaining wall 3 can contain part of the alignment liquid, thus slowing down the tendency of spreading out of the alignment liquid to the second coating region 12 and reducing the risk of spreading out of the alignment liquid and overlapping with the seal, influencing the quality of the cell.

Specifically, please refer to FIG. 1, in this exemplary embodiment, the inner retaining wall 2 is defined in a ragged manner along the circumference of the first coating region 11, so that when the alignment liquid is spread out to the inner retaining wall 2, part of the alignment liquid can pass through the low-lying portion of the inner retaining wall 2 more easily, thus avoiding the occurrence of the overflow of the alignment liquid due to the blocking of the inner retaining wall 2.

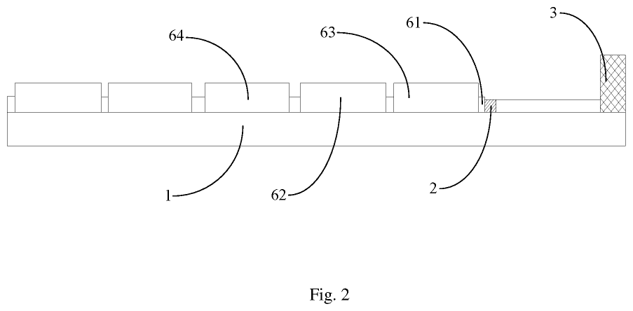

The inner retaining wall 2 can be defined in a variety of ways, including the inner retaining wall 2 can be defined discontinuously, please refer to FIG. 1 and FIG. 2. In this exemplary embodiment, the upper end of the inner retaining wall 2 is defined with a gap 21 so that the inner retaining wall 2 is defined in a ragged manner, thus having a better blocking effect on the distribution liquid at the low-lying position of the inner retaining wall 2 and effectively slowing down the trend of spreading out of the distribution liquid.

When part of the alignment liquid passes through the inner retaining wall 2, it will be contained in the region between the inner retaining wall 2 and the outer retaining wall 3 under the blocking action of the outer retaining wall 3. Specifically, please refer to FIGS. 1 and 2, in this exemplary embodiment, a containing region is formed between the inner retaining wall 2 and the outer retaining wall 3, and the part of the containing region is concavely defined compared with other parts to form an anti-overflow groove 4. Through the arrangement of the anti-overflow groove 4, the volume of the containing region can be relatively increased.

Further, when a plurality of the anti-overflow grooves 4 are formed in the containing region along a circumferential direction of the first coating region 11, the volume of the containing region is relatively large and the effect of slowing down the spreading out of the alignment liquid is relatively good.

Please refer to FIG. 1. In this exemplary embodiment, the anti-overflow groove 4 is defined corresponding to the low-lying portion of the inner retaining wall 2, because the low-lying portion of the inner retaining wall 2 has a relatively small blocking effect on the alignment liquid, the amount of alignment liquid passing through the low-lying portion of the inner retaining wall 2 is larger, and the anti-overflow groove 4 is defined corresponding to the low-lying portion of the inner retaining wall 2, which can reduce the tendency of effectively slowing down the further spreading out of alignment liquid passing through the low-lying portion.

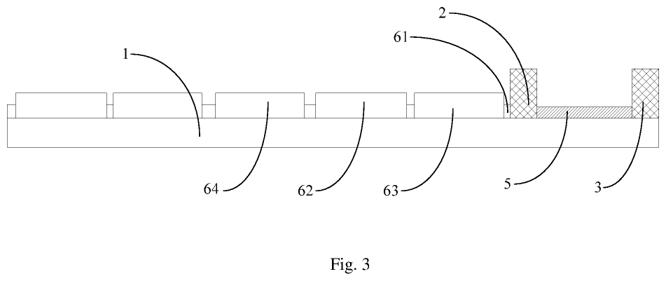

There are various ways to provide the anti-overflow groove 4 in the receiving region, but the anti-overflow groove 4 is defined in the substrate 1. Please refer to FIGS. 1 and 3. In this exemplary embodiment, the substrate 1 is convexly defined with a plurality of spacer blocks 5 connecting the inner retaining wall 2 and the outer retaining wall 3, the spacer blocks 5 are defined at intervals along a circumferential direction of the first coating region 11, and the anti-overflow groove 4 is formed between two adjacent spacer blocks 5. The casting process of the anti-overflow groove 4 is comparatively simple, and the spacer blocks 5 can be formed integrally with the inner retaining wall 2 and the outer retaining wall 3, made from the same material. Regarding to the material limitation of the inner retaining wall 2 and the outer retaining wall 3, in some embodiments, are made from insulated materials, avoiding interference to the electric field of the array substrate of the display panel.

As for the definition of the materials of the inner retaining wall 2 and the outer retaining wall, in this exemplary embodiment, the inner retaining wall 2 and the outer retaining wall 3 are both made of insulating materials, so that the inner retaining wall 2 and the outer retaining wall 3 will not interfere with the electric field of the array substrate of the display panel.

In this exemplary embodiment, the package substrate mechanism is a color film substrate, and the inner retaining wall 2 and the outer retaining wall 3 can be formed by providing a black matrix, a photo-resist layer or a spacer on the side of the substrate, for example, the substrate 1 can be defined with a black matrix, and the black matrix is convexly defined in the spacing region around the first coating region 11 to form the inner retaining wall 2 or the outer retaining wall 3; Optionally, the substrate 1 may be defined with a photo-resist layer, and the photo-resist layer may be convexly defined in the spacing region around the first coating region 11 to form the inner retaining wall 2 or the outer retaining wall 3. It is also possible that the substrate 1 is defined with a spacer, and the spacer is convexly defined in the spacing region around the first coating region 11 to form the inner retaining wall 2 or the outer retaining wall 3.

The inner layer retaining wall 2 and the outer layer retaining wall 3 are defined between the first coating region 11 and the second coating region 12. Specifically, in this exemplary embodiment, the distance between the first coating region 11 and the second coating region 12 is a, and the distance between the inner layer retaining wall 2 and the outer layer retaining wall 3 is b, where a−b is less than or equal to 9 mm, so that the inner layer retaining wall 2 and the outer layer retaining wall 3 have a better effect of double blocking the alignment liquid, and the capacity, formed by between the inner layer retaining wall 2 and the outer layer retaining wall 3, for the alignment liquid is relatively large.

Generally, the first coating region 11 is defined with a film layer 6 (see FIGS. 2 and 3, in this exemplary embodiment, the film layer 6 includes a plurality of black matrices 61 defined at intervals, and a red color resist layer 62, a green color resist layer 63, and a blue color resist layer 64 defined between the plurality of black matrices 61. When the height of the lateral surface of the film layer 6 is h (specifically, in this exemplary embodiment, the height of the lateral surface of the film layer 6 is the height of the black matrix 61), the inner retaining wall 2 is the lowest (in this exemplary embodiment, the height of the black matrix 61). The lowest point of the inner retaining wall 2 (in the present embodiment, the concave of the inner retaining wall 2) is d, in which, when h−d≤4 μm, outflow of the alignment liquid is avoided and a part of the alignment liquid is accommodated in the region between the inner retaining wall 2 and the outer layer retaining wall 3. The extension trend of the alignment liquid is thus avoided.

The above is only an alternative exemplary embodiment of the present application and is not intended to limit the patent scope of the present application. Any equivalent structural change made by using the contents of the specification and drawings of the present application or directly/indirectly applied in other related technical fields is included in the patent scope of the present application under the inventive concept of the present application.

What is claimed is:

1. A package substrate mechanism, comprising:
a substrate, having a first coating region and a second coating region located at an outer side of the first coating region, the first coating region and the second coating region being defined in intervals to form a spacing region between the first coating region and the second coating region; and
an inner retaining wall and an outer retaining wall, protruded on the substrate and defined internal and external, the inner retaining wall and the outer retaining wall being distributed in the spacing region and being defined around the first coating region.

2. The package substrate mechanism of claim 1, wherein, the inner retaining wall is defined in a rugged manner along a circumferential direction of the first coating region.

3. The package substrate mechanism of claim 2, wherein, a gap is defined at an upper end of the inner retaining wall, allowing the inner retaining wall defined in a rugged manner.

4. The package substrate mechanism of claim 1, wherein, a receiving region is formed between the inner retaining wall and the outer retaining wall, and a part of the receiving region is concavely defined compared with other parts, forming an anti-overflow groove.

5. The package substrate mechanism of claim 4, wherein the inner retaining wall is defined in a rugged manner along a circumferential direction of the first coating region, and the anti-overflow groove is defined at a low-lying portion of the inner retaining wall.

6. The package substrate mechanism of claim 4, wherein, the substrate is convexly defined with a plurality of spacer blocks connecting the inner retaining wall and the outer retaining wall in the receiving region, the spacer blocks are defined at intervals along a circumferential direction of the first coating region, and an anti-overflow groove is formed between two adjacent spacer blocks.

7. The package substrate mechanism of claim 6, wherein, the spacer blocks are integrally formed with the inner retaining wall and the outer retaining wall.

8. The package substrate mechanism of claim 4, wherein, the anti-overflow grooves are formed in the receiving region along a circumferential direction of the first coating region.

9. The package substrate mechanism of claim 1, wherein, the inner retaining wall and the outer retaining wall are made of an insulating material.

10. The package substrate mechanism of claim 1, wherein, a distance between the first coating region and the second coating region is a, a distance between the inner retaining wall and the outer retaining wall is b, and a−b is ≤9 mm.

11. The package substrate mechanism of claim 1, wherein a film layer is defined in the first coating region, a height of a lateral surface of the film layer is h, a height of the lowest portion of the inner retaining wall is d, and h−d is ≤4 micrometers.

12. The package substrate mechanism of claim 11, wherein, the film layer comprises a plurality of black matrices defined at intervals, and a red photo-resist layer, a green photo-resist layer and a blue photo-resist layer defined between the plurality of black matrices.

13. The package substrate mechanism of claim 12, wherein, the height of the lateral surface of the film layer is a height of one of the black matrix.

14. The package substrate mechanism of to claim 11, wherein, the inner retaining wall is defined in a ragged manner along a circumferential direction of the first coating region, and a low-lying portion of the inner retaining wall is the lowest.

15. The package substrate mechanism of claim 1, wherein, the package substrate mechanism is a color film substrate or an array substrate.

16. The package substrate mechanism of claim 1, wherein, the package substrate mechanism is a color film substrate, the substrate is defined with a black matrix, and the black matrix is convexly defined in the spacing region around the first coating region to form the inner retaining wall or the outer retaining wall.

17. The package substrate mechanism of claim 1, wherein, the package substrate mechanism is a color film substrate, the substrate is defined with a photo-resist layer, and the photo-resist layer is convexly defined in the spacing region around the first coating region to form the inner retaining wall or the outer retaining wall.

18. The package substrate mechanism of claim 1, wherein the package substrate mechanism is a color film substrate, the color film substrate is defined with a spacer, and the spacer is convexly defined in the spacing region around the first coating region to form the inner retaining wall or the outer retaining wall.

19. A display panel, comprising a package substrate mechanism comprising:
a substrate, having a first coating region and a second coating region located at an outer side of the first coating region, the first coating region and the second coating region being defined in intervals to form a spacing region between the first coating region and the second coating region; and
an inner retaining wall and an outer retaining wall, protruded on the substrate and defined internal and external, the inner retaining wall and the outer retaining wall being distributed in the spacing region and being defined around the first coating region.

20. A display device comprising a display panel, the display panel comprising a package substrate mechanism, the package substrate mechanism comprising:
a substrate, having a first coating region and a second coating region located at an outer side of the first coating region, the first coating region and the second coating region being defined in intervals to form a spacing region between the first coating region and the second coating region; and
an inner retaining wall and an outer retaining wall, convexly defined on the substrate and defined internal and external, the inner retaining wall and the outer retaining wall being distributed in the spacing region and being defined around the first coating region.
